(19) United States
(12) Patent Application Publication
(10) Pub. No.: US 2003/0093438 A1
(43) Pub. Date: May 15, 2003

(54) System and method for performing reverse DNS resolution

(76) Inventor: David Miller, Sidney, ME (US)

Correspondence Address: BANNER & WITCOFF, LTD., 28 STATE STREET, 28th FLOOR, BOSTON, MA, 02109, US

(21) Appl. No.: 10/290,671

(22) Filed: Nov. 8, 2002

Related U.S. Application Data
(60) Provisional application No. 60/345,330, filed on Nov. 9, 2001.

(51) Int. Cl. G06F 7/00

(52) U.S. Cl. 707/104.1

(57) ABSTRACT

A system for reverse DNS resolution has a first processing apparatus in communication with a network and a second processing apparatus in communication with the first processing apparatus via the network. DNS and other data is collected from the network using the first processing apparatus, processed and provided to the second processing apparatus for use in reverse DNS resolution performed at the second processing apparatus.

### FIELD OF THE INVENTION

This invention relates to DNS resolution and more specifically reverse DNS resolution.

### BACKGROUND OF THE INVENTION

Every device attached to an Internet Protocol (IP) network is uniquely identified by a 32-bit number called an IP address. This numeric address is used for all communications with the device, be it a personal computer running a web browser or a server providing web pages. Humans, however, remember and work with names better than numbers, making a service that translates numbers into names and addresses very valuable. Such a system, called the Domain Name Service (DNS) was developed as part of the Internet.

DNS is a system that translates human recognizable hostnames into numbers, and numbers back into hostnames. For example, the name www.miningworks.com translates to the IP address 207.5.180.163. Numeric addresses can also be translated by the DNS system to find their corresponding hostnames. This process is called DNS resolution. Forward resolution finds the numeric IP address that corresponds to a given name. Reverse resolution finds the name that corresponds to a given numeric IP address.

Web sites often keep a log of the addresses of the visitors to the site. The reverse resolution of log files is fundamental to any web site traffic analysis. Resolved log files are the foundation for additional detailed analysis, including information about domain names, countries of origin, and network providers.

The rate and the reliability with which addresses can be resolved are critical to organizations that wish to analyze log files for their Internet servers. Resolution utilities currently available are not sufficiently fast and reliable to make use of the hostname in real-time. Resolution utilities in use today send queries to a local caching name server. This server is used by many local systems, and it remembers, or caches, the results of the queries most recently made. If the address is not in its cache, this local caching name server will attempt to resolve the address over the Internet. Because resolving queries over the Internet is often at least an order of magnitude slower than doing so at the local caching server, these utilities typically have the means to resolve from one hundred to one thousand queries in parallel. The performance of these resolution utilities systems ranges from two hundred names per second for average systems to one thousand names per second for the most sophisticated systems with excellent network connections.

DNS is a widely distributed system. Centralized administration of DNS is limited to a small group of “Top Level Domain” or TLD servers. These TLD servers hold a list of the servers that in turn hold the data for all sub domains that comprise the top-level domain. Each individual organization must then run DNS servers for its own domain. Running its own DNS server gives the organization control of all aspects of its DNS data, including such attributes as hostname, IP address, and how long the address is valid. For example, the server a.gtld-servers.net is one of the TLD servers for the “.com” domain. The address a.gtld-servers.net will not resolve vhost-1.rsn.com. It will, however, list two name servers that will translate it: dnsl.olympus.net and named.rsn.com. Either of these servers can be asked to resolve any address ending in “.rsn.com.” Changes to the rsn.com domain are made by RSN staff on named.rsn.com. The address dnsl.olympus.net is a “mirror” of named.rsn.com, containing all DNS data related to the rsn.com domain.

This system generally works quite well. Having multiple TLD servers means that the resolution process can be started even if considerable portions of the network are unavailable. Domain owners are encouraged to have multiple name servers for their own domains, and to place them with network and geographic diversity.

However, there are several performance issues:

1. Resolving a DNS query requires responses from at least two systems, and often three or more.

2. Network conditions may slow resolution by “dropping” queries at overloaded sections of the Internet. If network conditions are extremely bad, “dropped packets” prevent resolution from occurring at all.

3. The name server(s) that have the DNS data required to resolve a query may be unavailable for any number of reasons, including router problems, administrative problems, or the server itself not running.

Even when none of these problems arise, a query is slowed by the very fact that one or more remote name servers must be contacted over the Internet. Therefore what is needed is a system that does not suffer from these limitations.

### SUMMARY

In accordance with a first aspect, a system for performing reverse resolution comprises a communication network, a first processing apparatus in communication with the communication network adapted to collect and process DNS data, and a second processing apparatus, in communication with the first processing apparatus via the communication network, adapted to receive DNS data collected and processed by the first processing apparatus and to perform reverse DNS resolution using the received DNS data.

In accordance with another aspect, a method of reverse DNS resolution comprises the steps of: gathering DNS data using a first processing apparatus, processing gathered DNS data to generate a processed data set; providing the processed data set to a second processing apparatus; and performing reverse DNS resolution using the provided processed data set with the second processing apparatus.

These and additional features and advantages of the invention disclosed here will be further understood from the following detailed disclosure of certain preferred embodiments.

### BRIEF DESCRIPTION OF THE DRAWINGS

FIG. 1 is a diagrammatical representation of one embodiment of a reverse resolution system.

FIG. 2 is a generalized flow diagram showing one embodiment of the acquisition and storage of data in the system of FIG. 1.

FIG. 3 is a generalized flow diagram providing a more detailed description of the gathering of data in the system of FIG. 1.

FIG. 4 is a generalized flow diagram of the process of providing the data gathered to the second processing apparatus in the system of FIG. 1.

The figures referred to above should be understood to present a representation of the invention, illustrative of the principles involved. Some features of the system and method depicted in the drawings are focused on over others to facilitate explanation and understanding. The same reference numbers are used in the drawings for similar or identical components and features shown in various alternative embodiments. The system and method as disclosed herein, will have configurations and processes determined, in part, by the intended application and environment in which they are used.

### DETAILED DESCRIPTION OF CERTAIN PREFERRED EMBODIMENTS

The following terms are referred to throughout this detailed description. Reference to the following definitions may be helpful to the understanding of the system embodiments disclosed below.

AS-Number: Autonomous System Number. This is a number assigned to all multi-homed Internet Providers. Analyzing web logs by AS-number helps a company determine its network connectivity needs and strategies.

Appending: Adding additional information to the end of a hostname. For example, the client may choose to append the country code to the hostname, transforming “12.comp-services.colby.edu” to “12.comp-services.colby.edu.us.”

Backbone Provider: One of the major providers of the Internet, generally having many points of presence in more than one country. UUNet, Sprint, AT&T, and Cable & Wireless are examples of backbone providers.

BGP: Border Gateway Protocol. The standard routing protocol used on the Internet to make networks available from anywhere.

Detailed Central Database: The database containing all stored detailed information, including names and IP addresses, routing registry data, data required to harvest additional data, time data was harvested, etc. This database is used to generate updates for clients.

Distribution/Update Systems: Computers which make the appropriate database updates available to clients.

Dropped Packets: The basic networking unit of information is called a “packet.” This is a portion of the data in a network connection, and might be part of an email message, an image on a web page, or a DNS query. When communications links are overloaded, excess packets cannot be transmitted and are “dropped.” Some applications, such as DNS, will wait for a short time and then, not having received a response, will retransmit the packet.

Domain: A domain is a collection of systems based on name. For example, Comp-services.colby.edu is a domain. It is also a subdomain of colby.edu, a larger domain. Colby.edu, by extension, is a subdomain of .edu, which is itself a subdomain of “root,” usually referred to by a period.

DNS: Domain Name Service. The protocol on the Internet that translates names and numbers.

End Device: A device on which Internet information is downloaded for access by an end-user.

End Device Speed: The rate at which information can be downloaded to an end device.

Harvesting Computer: A computer system that gathers or “harvests” DNS and routing registry, routing table, and registrar data over the Internet.

IP address: A unique, 32 bit address which identifies a particular device on the Internet.

Latency: Latency is the time delay between two events. The latency of a network is the time it takes for a packet to travel to a device and back.

Limiting Speed: Limiting speed, an item of interest for many clients, is the slowest network speed between a web server and the web site visitor. This is not necessarily the same as the End Device Speed. It is the same for the average home user. For environments where a local LAN is connected via a slower link, it is the slower link that is of interest, not the local LAN speed.

Local Disclosed Systems Server: Software that runs on a computer on the client's physical premises and resolves reverse DNS queries.

Network Blocks: Groups of IP address which are consecutively numbered. What has traditionally been called a “class C” network block is a group of 256 IP addresses, and is referred to as A.B.C.0. A “class B” network is a group of 65536 addresses, all of which start with “A.B.0.0.” For example, 137.146.0.0 is a class B network used by Colby College.

Prepending: Adding additional data to the front of a hostname. The client may choose to prepend the device speed, transforming “12.comp-services.colby.edu” into “MWHS.12.comp-services.colby.edu.” MWHS being an abbreviation for “Mining Works High Speed.”

Real-time: The occurrence of an activity upon its activation. Real-time resolution of IP addresses requires a web site visitor to wait for the resolution of the address before the web page is sent back.

Resolution: The process of translating a name to an IP address (Forward resolution) or an IP address to a name (Reverse Resolution).

Resolution Utilities: Resolution utilities read in a raw Web log file and resolve the IP addresses into hostnames. Once the log file is “resolved” utilities can perform analysis based on hostname.

Routing Registries: Databases maintained by Internet Service Providers that contain information about IP addresses, routes, administrative contacts, and several other items.

Routing Tables: List of networks reachable on the Internet. Every backbone router on the Internet has a routing table so it knows which neighbor to send a packet to, so that the packet eventually reaches its intended destination.

SOA Record: Start of Authority Record, SOA, is a “master record” for a DNS zone. This record contains a serial number that applies to the zone, data required by the backup name servers, and an administrative contact.

Synthesizing: The process of creating a hostname with the best available data that did not originate within the DNS system.

Database of Updates: A database used to store the changes that have occurred between the present and some previous time to client databases.

Zone file: A logically grouped set of DNS data available for transfer. For example, the domain colby.edu would have a zone file with all hosts which end with “.colby.edu.” Performing a “zone transfer,” or copying this file, gives one all the DNS data for that domain.

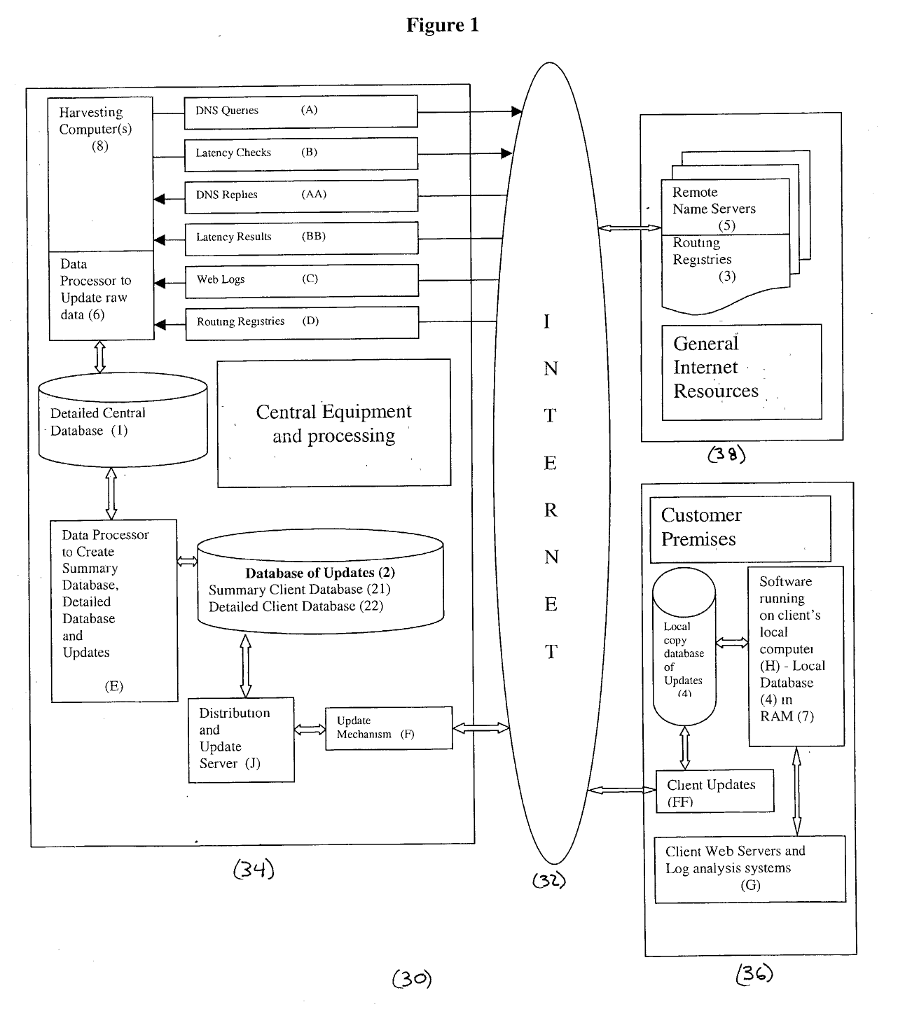

In accordance with a first embodiment, as shown in FIG. 1, a reverse resolution system (30) comprises a network (32), depicted here as the Internet; a first processing apparatus (34), depicted here as central equipment and processing; with a harvesting computer (8) having a data processor (6), a detailed central database (1), a database of updates (2), and a distribution and update server (J); and a second apparatus (36), depicted here as customer premises, with a local customer database (4), software running on a client's computer (4) with a RAM (7), and client web servers (G). The first processing apparatus (34) is in communication with the network (32), and is adapted to collect and process DNS data (A)(AA). The second processing apparatus (36) is in communication with the first processing apparatus (34) via the network (32). The second processing apparatus (36) is adapted to receive the DNS data collected and processed by the first processing apparatus (34) and perform reverse DNS resolution using the collected and processed DNS data. In certain preferred embodiments the first processing apparatus (34) is further in communication with general Internet resources (38) via the communication network (32). In certain embodiments other data in addition to the DNS data is collected from the Internet resources. Such additional data can include, for example, latency data (BB), web log data (C) or other Internet server log data (not shown) which includes, but is not limited to, ftp, video, or audio server log data, domain name registry data (not shown), and routing registry data (D). The DNS data and additional data are discussed in more detail herein below.

In the embodiment above the communication network is the Internet. It should be noted that this is but one of the possible embodiments for a communication network. Other embodiments will be apparent to one skilled in the art given the benefit of this disclosure.

As disclosed above, in preferred embodiments, the first processing apparatus (34) includes a harvesting computer (8), a detailed central database (1), a database of updates (2), and a distribution and update server (J). In certain preferred embodiments the harvesting computer includes a data processor (6) for processing the data collected. In certain preferred embodiments the first processing apparatus comprises multiple harvesting computers. The harvesting computer (8) may be any computer suitable for accessing a network, such as the Internet, to collect data. Suitable harvesting computers include, but are not limited to, computers such as servers sold by IBM, Dell, Sun or the like, using processors such as those manufactured by Intel, AMD, Sun, or the like, running an operating system such as Windows, Unix, Linux or the like. The term database as used here refers to the data, the software used to organize the data, as well as the media on which data is stored. Suitable database software includes, but is not limited to, database programs such as those made by Microsoft, Oracle, or the like. Suitable media for databases include, but are not limited to, RAM, magnetic media such as floppy disks, hard drives, tapes, etc., or optical media such as CDs or DVDs. The distribution and update server (5) may be any computer suitable for performing as a server to distribute data. Suitable distribution and update servers include, but are not limited to, computers such as servers sold by IBM, Dell, Sun or the like, using a processors such as those manufactured by Intel, AMD, Sun, or the like, running an operating system such as Windows, Unix, Linux or the like. In certain embodiments the functionality of the update and distribution server (5) is provided by the harvesting computer (8). In certain embodiments the harvesting computer (8) and databases (1) are provided in a single device. In one particular embodiment the first processing apparatus is a 2.4 Ghz Intel Xeon system from Dell with 2 GB of RAM and a 12 disk RAID array running the FreeBSD operating system and using MySQL database software. It should be noted that these are but a few of the possible embodiments for the first processing apparatus. Other embodiments will be apparent to one skilled in the art given the benefit of this disclosure.

The second processing apparatus (36), also referred to here as the customer premises, is typically where a customer or client receives the information collected and processed by the first processing apparatus (34). In preferred embodiments, as disclosed above, the second processing apparatus (36) includes a computer (H) having RAM (7) and a web server (G). Suitable computers (H) and web servers (G) include, but are not limited to, computers or network appliances such as those sold by IBM, Dell, Sun or the like, using a processors such as those manufactured by Intel, AMD, Sun, or the like, running an operating system such as Windows, Unix, Linux or the like. In certain embodiments the computer (H) and web server (G) are incorporated in the same device. In one particular embodiment the second processing apparatus (36) is a computer with an Intel Pentium 4 processor, a compact flash adapter, and 512 MB of RAM running the modified version of the FreeBSD operating system. In certain embodiments the received collected and processed DNS data is stored in the RAM of the computer for quicker access in performing reverse DNS resolution. It should be noted that these are but a few of the possible embodiments for the second processing apparatus (36). Other embodiments will be apparent to one skilled in the art given the benefit of this disclosure.

In certain preferred embodiments, where the first processing apparatus (34) is further in communication with general Internet resources (38) via the communication network (32), the general Internet resources comprise a remote name server (5), a routing registry (3), and a domain name registry (not shown). Other embodiments will be apparent to one skilled in the art given the benefit of this disclosure.

In accordance with another embodiment, a method of reverse DNS resolution comprises gathering DNS data from a network using a first processing apparatus, processing gathered DNS data to generate a processed data set, providing the processed data set to a second processing apparatus, and performing reverse DNS resolution using the provided processed data set with the second processing apparatus. In preferred embodiments the method further comprises storing the gathered DNS data. Other embodiments include the step of storing the processed data set. In certain preferred embodiments the step of gathering DNS data includes periodically updating the gathered DNS data. As with the system, in certain embodiments additional data is gathered as well as the DNS data. This additional data may be periodically updated as well. Further discussion of this method may be found herein below.

In certain preferred embodiments, processing the DNS data to generate a processed data set involves generating a client database. In certain embodiments, processing the DNS data to generate a processed data set involves generating a summary client database. Typically the processed data set includes at least some of the DNS data and/or additional data. In some embodiments the processed data set includes summaries of the DNS and/or additional data.

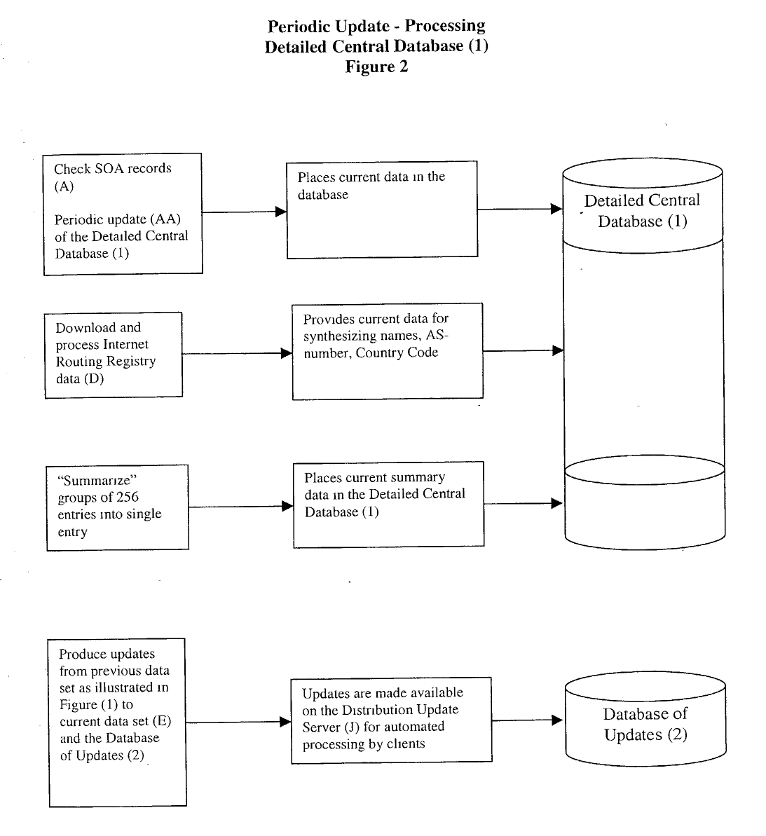

A general overview of one embodiment for gathering data and processing and storing gathered data can be seen in FIG. 2. The gathering, processing and storing of data are discussed in more detail below.

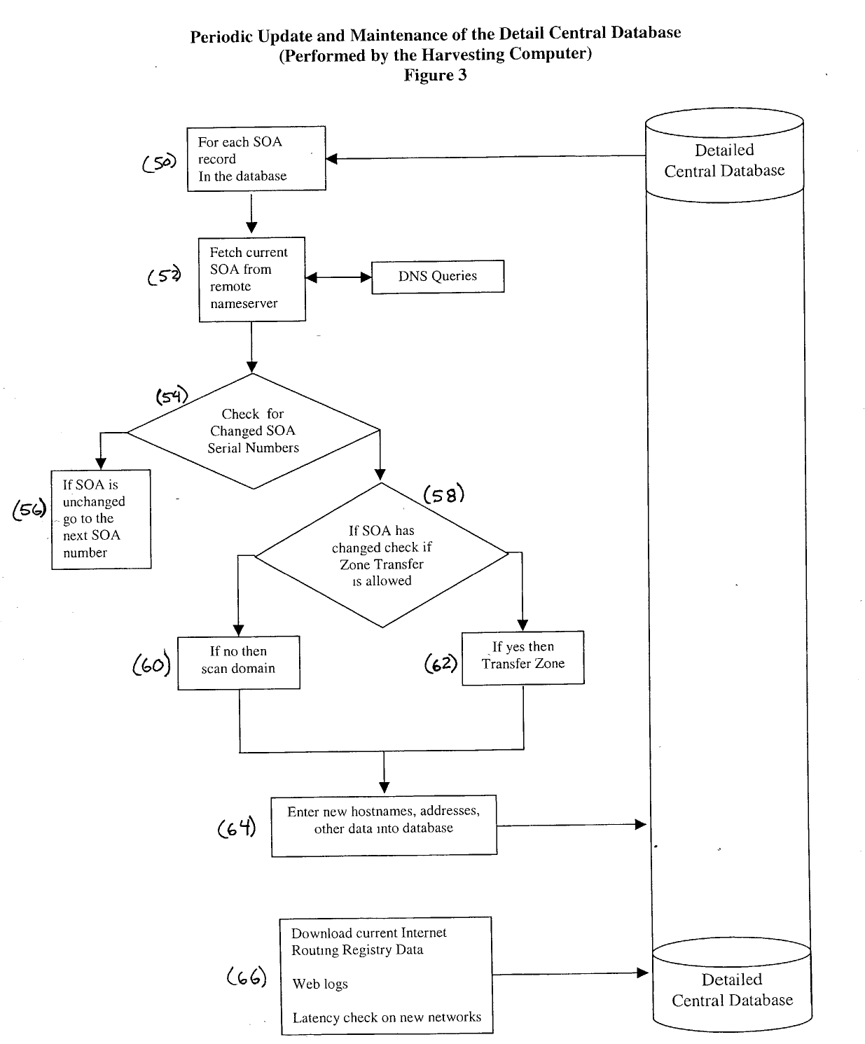

FIG. 3 shows an embodiment wherein gathering DNS data includes obtaining a Start of Authority (SOA) record from a database (50); fetching a current SOA record from a remote nameserver (52); checking for a change in the SOA record serial number (54); if SOA serial number is unchanged going repeating the first step (56), otherwise checking if zone transfer is allowed (58); if transfer is not allowed, then scanning domain (60); if transfer is allowed, then transferring zone (62); entering new data into the database (64); obtaining new additional data (64); and entering additional data into the database (66). The process and methodology of these steps are further described herein below.

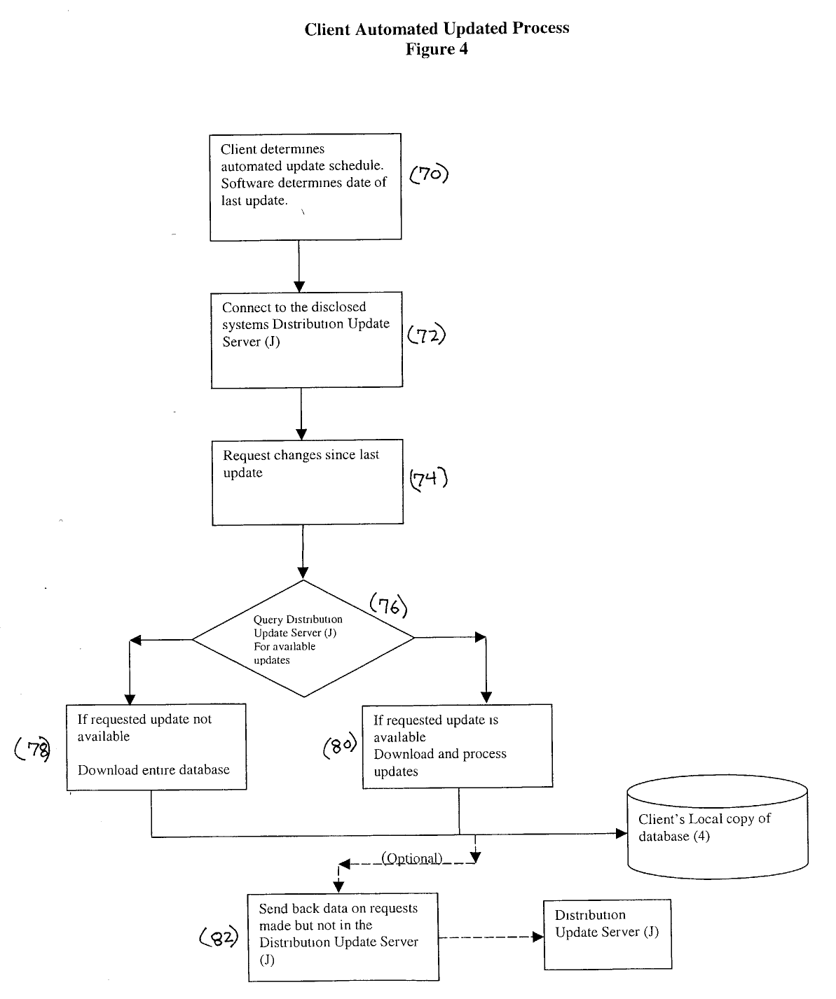

FIG. 4 shows an embodiment of wherein providing processed data to a second processing apparatus includes determining an update schedule at the second processing apparatus (70), connecting to a distribution update server at the first processing apparatus (72), requesting any changes to processed data set since previous request (74), querying distribution update server for available updates to processed data set (76), if no updates are available, then downloading entire processed data set (78), if updates are available, then downloading updates to processed data set (80). Certain preferred embodiments further include sending, from the second processing apparatus to the first processing apparatus, data regarding requests made but not in distribution update server (82).

The following is a discussion of the operation and methodology of certain preferred embodiments. The examples are provided for illustrative purposes. Those skilled in the art will recognize various other embodiments given the benefit of this disclosure.

DNS Data

The process of gathering and maintaining data is described with additional reference to FIGS. 1, 2 and 3. Because certain preferred embodiments of the disclosed system provide a way to accelerate access to information that is already publicly available, the data may be freely gathered over the Internet. There currently are three principal sources of this data, as shown in FIG. 1: The DNS system itself, denoted at (3), domain registrars, and “routing registries,” denoted as (5), which backbone providers maintain for their networks. Information stored in these routing registries includes, e.g., network blocks, the AS-number to which they are assigned, contacts for the network blocks, and the address at which the block is deployed. The disclosed system employs the DNS system as the source of hostnames and the routing registries as the source of synthesized names, country codes, and AS-number options.

Currently, there are over four billion IP addresses available to the Internet today with the current version, version 4, of the Internet Protocol. Over 200 million of them have host names entered into the DNS system. The task of gathering all available DNS data is significant. As described in greater detail below, certain preferred embodiments of the disclosed system start with the in-addr.arpa “zone” file that lists the domains and their name servers. These name servers are then divided into two categories depending on whether they allow “zone transfers.” Zone transfers are a standard mechanism by which all entries in a particular domain, or “zone” are transferred as a single file. Zone transfers have traditionally been allowed from anywhere on the Internet. In the last several years, however, some administrators have disabled this feature for reasons of security. This practice does not necessarily stop the data gathering process of the disclosed system.

The initial DNS data is gathered by transferring zones where allowed and scanning (querying all possible addresses in the zone) where transfers are not allowed. This data is stored in the detailed central database (1) for later use.

For example, the network “137.146” is assigned to Colby College. Any address which begins with “137.146,” such as 137.146.210.34, “belongs” to Colby College. They control the domain “colby.edu” and provide several name servers for it. This lets resolvers translate names, such as www.colby.edu, into addresses such as 137.146.210.34. They are also responsible for the reverse entries for their addresses in the domain 146.137.in-addr.arpa. Thus, for example, 137.146.210.34 will have an entry in the zone 34.210.146.137.in-addr.arpa that points to www.colby.edu.

The domain 146.137.in-addr.arpa can have up to 65536 entries. If a majority of these entries have been made, there is little difference in the effort of a zone transfer compared to querying all possible entries. If there are relatively few entries, however, a zone transfer is much more efficient. There are no cases where a zone transfer is less efficient than querying the entire network.

Addresses Not in DNS

Some Internet Service Providers neglect to enter their addresses in the DNS system. Having some information about these addresses is usually better than having none. The Internet Routing Registries (D) or IRR's, and the domain registrars provide a considerable amount of information about most IP addresses in use on the Internet today. This information includes the registrant and some gross geographic details, including the country. These databases can be downloaded periodically.

This IRR data is used to provide the country code and AS-number for all addresses in certain preferred embodiments of the disclosed system database. The registrant of the network is used to synthesize a name for IP addresses that have not been entered in DNS. While this name is an approximation, it is an option to provide the most useful information available about the address. The country code, AS-number, and speed of the device are not dependent on data in the DNS system.

Gathering the Data

Some or all of the following exemplary data types are gathered and processed by preferred embodiments of the methods and systems disclosed here.

Device Speeds

The DNS data (AA), latency data (BB), web log file data (C) other server log file data (not shown) which includes, but is not limited to, ftp, video, or audio server log data, domain name registry data, and routing registry data (D) are gathered by one or more harvesting computers (8). This data is stored in the detailed central database (1) after processing by a data processor to update raw data (6). The processor (6) functions to add DNS data to the detailed central database (1) if it is new data, and to change data in the detailed central database (1) if it is changed data. Preferably, deleted data is retained in the detailed central database (1) for archival use. There are two principal sources of “end-device” speed data. The first is an analysis of latency between the device itself and several devices “upstream” from the device. The second is an analysis of web or ftp log files from various sites around the Internet.

“Latency” is the time a packet takes to travel to a device and back. It is a measure of time, not speed. For example, a high-speed satellite connection may also have high latency because the packets must travel to a satellite and back. A device connected via a cable modem, which transmits packets with very low latency, may be, for example, rate limited by its ISP. Finally, a high-speed last hop may still have an upstream bottleneck when an ethernet LAN is connected to the Internet via a dialup connection. However, latency provides a useful approximation of device speed based on the time required to transmit a packet of known size. On occasion the last several hops will be analyzed, such as when a high speed LAN has a low speed connection.

The “last hop” latency (B) (BB) can be measured by using “traceroute” to determine the network path to the device and finding the latency to the last two points. Traceroute is a common network analysis tool that reports each of the network devices a packet travels through on its way to the end device. By measuring the difference in latency between the last two points a reasonable estimate of the speed of the network link connecting them can be made. In some embodiments the latency is measured between the end device and a point several “hops” prior to the end device. An example of this is a high-speed network connected by a low speed link; the last two devices will show a very low latency whereas the last device and the third-last device will show the limiting speed.

All that is required to take this measurement are a device or two per network that respond to traceroute and “ping.” Access will be blocked to some networks, but a good “best guess” can be made for most networks. Latency measurements will provide data for nearly all networks, regardless of their ability to show up in a web log.

A second source of data for device speeds is the log files (C) produced by many types of Internet servers, including web servers, FTP servers, and multimedia (audio or video) servers. As these servers provide files to users they can log many data items. One of these items is the time required for the download to take place. Web browsers will normally establish multiple connections to a web server to ensure the pages are downloaded to the browser in the minimum time possible. Because there are multiple simultaneous connections, no individual connection will get all the bandwidth available. However, all the data transferred to a device between the time the first connection starts and the last one completes can be totaled, and the rate determined accordingly. This does not constitute an ideal solution. The end device will look slower than it actually is if it is transferring data from other sites on the Internet, sharing the link with another busy computer, or there is a network slowdown between the server and end device. It will look faster than it actually is with some kinds of transfers if link compression is enabled, as is the case on most dialup connections.

Large data sets are gathered over time from a variety of web and FTP sites around the Internet. This data is continually fed into the detailed central database (1), and the latest and best approximations of limiting speeds are determined periodically (E).

Keeping the Database Current

The following features relate to preferred embodiments of the systems and methods disclosed here.

DNS Data

Data is constantly being changed in the global DNS system. Entries are being added as the Internet grows, deleted as old address space is re-allocated, and changed as hostnames are given new attributes. A database of 200 million names is out of date before it can be fully gathered.

DNS was designed with a built-in protocol to handle servers, generally denoted at (3), that are not responding or not reachable over the network. One server is designated as “master” for the domain, and one or more “slaves” are designated as “secondary” servers. The secondary servers check with the master on occasion to see if the “serial number” for the zone has changed. The administrator for the domain must change the serial number when she changes any data.

The detailed central database (1) is kept synchronized with general Internet resources by tracking changes to such serial numbers. Testing shows that approximately 7% of all zone serial numbers are changed per day. Because changes are more likely in the larger domains, simply because they have more hosts entered, somewhat more than 7% of the data must be checked on a daily basis. Note that this does not indicate that 7% of the data in the client database (4) will change daily. If a single host is added to a domain with 250 other entries, for example, the serial number must be updated but the summarized entry will likely remain unchanged.

The summarization process works on groups of addresses. In a preferred embodiment, a group is composed of 256 addresses. It takes those present from the range and essentially votes on the most popular name. For example, all the hostnames for 137.146.210.0 through 137.146.210.255 end in “.colby.edu,” and might well end in “.comp-services.colby.edu.” It is likely that there will be fewer than 256 entries for the sub-domain. It's very likely that adding a host to that network will not change the summarized version which would remain “.comp-services.colby.edu.” Using the summarized version of the service, provided by the embodiments disclosed here, addresses in the 137.146.201.xxx range will resolve to xxx.comp-services.colby.edu. A data processor (E) is used to (i) create a detailed client database (21) for storage and updating in the database of updates (2), (ii) create a summary client database (22) for storage and updating in the database of updates (2), and (iii) create updates for clients' databases. The detailed client database (21) includes essentially all the DNS entries included in the detailed central database (1). The summary client database (22) includes summarized version of the detailed client database.

The automated, periodic update process disclosed herein preferably includes the steps of:

Checking the serial number of all domains in the database (1).

Scanning domains for updated serial numbers, harvesting this data as appropriate, and entering the new data into the database (1).

Downloading the IRR data using the harvesting computer (8) and using the IRR data to update the database (1).

Running a process in the data processor (E) to determine changes to the database of updates (2) since the last update of the database (2).

Over some possibly less frequent period the reverse address space will be scanned to find any new or deleted domains. An additional source of network space to search comes from new networks being added to the global routing tables.

Keeping the Data Current

Some or all of the following exemplary data types are gathered and processed by preferred embodiments of the methods and systems disclosed here.

Device Speed Data

With device speeds there is no serial number to key on as with DNS. Therefore, device speeds are a constant search-and-update process. Log file analysis provides such data constantly. New networks, added to the global routing tables, need to have latency checks run.

A periodic automated testing of all networks in the routing tables needs to occur to keep the detailed central database (1) up to date. A network must have an entry in the routing tables in order to be connected to the Internet.

Finally, an optional feedback loop, represented by (F) to (FF), can be provided for the clients system for notification of networks missing from the detailed central database (1) as shown in FIG. 4.

Processing the Detailed Central Database

Preferred embodiments of the disclosed system read current data from the detailed central database (1) and creates the detailed and summary client databases and update files, included in the database of updates (2), for various periods. These updated files are requested by clients to update their respective local databases (4).

Distributing the Data

The process of updating a client's database can be described with reference to FIG. 4. When a client first begins using the service of certain preferred embodiments, their choice of the entire detailed client database or the entire summary client database will be downloaded. From that point on, automated updates to the database will suffice (F) to (FF). Each client system contacts a distribution update server (J) and asks for changes since it last requested an update. Once the client system has the required updates it applies them in chronological order to its own database. Upon completion, it directs the local disclosed systems software running on the client's computer (H) to use the new data obtained from the client's database (4).

Making the Data Available to Standard Clients

The information provided by the system of FIG. 1 to a client Web server (G) is made available by a standard protocol, making it more universally useful to clients in general. Because certain preferred embodiments of the disclosed system function to make DNS data available, the standard DNS protocol as specified in RFC 1035 and subsequently updated in RFC's 2181, 1886, 1183, 1706, 1123, 1591, and others, is a preferred standard to follow in the process disclosed herein, denoted by the link (G) to (H). In the present state of the art, the client at the customer premises would directly access the general Internet resources using the client web server (G). In certain preferred embodiments of the disclosed system, the software running on the client's local computer (4) functions to direct the client to the local DNS database (4), and to the RAM (7) when the RAM is provided to improve retrieval performance. Accordingly, certain preferred embodiments of the disclosed system require no direct link between the customer premises and the general Internet for the purpose of performing reverse resolution.

To update the local client's database (4), a request for updates is sent to the update server (J) in the central equipment and processing system (as indicated by client updates FF). Depending upon the particular service contract with the requesting client, either the summary client database (21) or the detailed client database (22) is accessed by the client. The requested data is downloaded into the client database (4). The frequency of the updates is a function of the contractual agreement in force between the client and the provider of the resolution services desired. In a preferred embodiment, some or all of the data in the local client's database (4) is copied into the RAM (7) for faster access, as is well known in the relevant art. When the client requires access to DNS data, for example, the data in the RAM (7) is accessed, rather than accessing the general Internet resources. In this manner, DNS and other supplied data can be obtained by the client in less time than if conventional methods were used.

Adding Additional Data to the Standard Hostname

In preferred embodiments, the disclosed systems server (H) provides additional fields by attaching them to the beginning or end of the name. For example, 123.ts1.splitrock.net could have the speed prepended and the country code appended, resulting in “MWDU.123.ts1.splitrock.net.us.” Reporting tools included in the client server (G) can then accurately determine the total visitors by country. The analysis of traffic by end-user connection speed can be accomplished by analysis of hostname.

Making the end device speed known in real-time as the visitor first arrives at a web site allows customization of the page to suit the end user. For example, being able to quickly look up the connection speed of visitors to a web site can allow customized response to different visitors. Web visitors connected by a dialup connection could be shown a “lightweight” page while visitors connected by a high-speed cable modems could be shown a much richer, graphical page.

By making reverse resolution and speed determination sufficiently robust, sites become customizable in real-time. Thus, for example, in accordance with certain preferred embodiments, web log file resolution can be integrated with serving web pages, thereby making a separate log resolution step unnecessary.

In accordance with certain preferred embodiments, other information may also be included in the additional data. The addition of Geo-location data may be beneficial for further customizing. Suitable Geo-location data includes information such as country, region, state, city or zip code.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A system for reverse DNS resolution comprising:
a communication network;
a first processing apparatus in communication with the communication network adapted to collect and process DNS data; and
a second processing apparatus, in communication with the first apparatus via the communication network, adapted to receive DNS data collected and processed by the first processing apparatus and to perform reverse DNS resolution using the received DNS data.

2. The system of claim 1 wherein the communication network comprises the Internet.

3. The system of claim 1 wherein the first processing apparatus is further in communication with general Internet resources via the communication network.

4. The system of claim 3 wherein general Internet resources comprise:
a remote name server;
a routing registry; and
a domain name registry.

5. The system of claim 1 wherein the first processing apparatus comprises:
a harvesting computer;
a detailed central database;
a database of updates; and
a distribution and update server.

6. The system of claim 5 wherein the first processing apparatus comprises a plurality of harvesting computers.

7. The system of claim 1 comprising a first processing apparatus further operative to collect and process additional data.

8. The system of claim 7 wherein the additional data comprises latency data.

9. The system of claim 7 wherein the additional data comprises web log data.

10. The system of claim 7 wherein the additional data comprises Internet server log data.

11. The system of claim 7 wherein the additional data comprises routing registry data.

12. The system of claim 11 wherein the routing registry data comprises country code data.

13. The system of claim 11 wherein the routing registry data comprises AS number data.

14. The system of claim 7 wherein the additional data comprises domain name registry data.

15. The system of claim 7 wherein the additional data comprises geo-location data.

16. The system of claim 1 wherein the second processing apparatus comprises:
a computer having RAM; and
a web server.

17. The system of claim 16 wherein the DNS data received from the first processing apparatus is stored in the RAM of the second processing apparatus.

18. A method of reverse DNS resolution comprising:
gathering DNS data from a network using a first processing apparatus;
processing gathered DNS data to generate a processed data set;
providing the processed data set to a second processing apparatus; and
performing reverse DNS resolution using the provided processed data set with the second processing apparatus.

19. The method of claim 18 further comprising storing the gathered DNS data.

20. The method of claim 18 wherein gathering DNS data comprises periodically updating the gathered DNS data.

21. The method of claim 18 further comprising gathering additional data.

22. The method of claim 21 wherein gathering additional data comprises gathering latency data.

23. The method of claim 21 wherein gathering additional data comprises gathering web log data.

24. The method of claim 21 wherein gathering additional data comprises gathering Internet server log data.

25. The method of claim 21 wherein gathering additional data comprises gathering routing registry data.

26. The method of claim 25 wherein the routing registry data comprises country code data.

27. The method of claim 25 wherein the routing registry data comprises AS number data.

28. The method of claim 21 wherein gathering additional data comprises gathering domain name registry data.

29. The method of claim 21 wherein gathering additional data comprises gathering geo-location data.

30. The method of claim 21 wherein gathering additional data comprises periodically updating gathered additional data.

31. The method of claim 21 further comprising processing the additional gathered data to generate a processed data set.

32. The method of claim 21 wherein the processed data set comprises at least part of the additional data grouped and categorized.

33. The method of claim 21 wherein the processed data set comprises a summary of the additional data.

34. The method of claim 21 wherein the processed data set comprises data synthesized from the additional data.

35. The method of claim 18 further comprising storing the generated processed data set.

36. The method of claim 18 wherein processing the gathered DNS data to generate a processed data set comprises processing the DNS data to generate a client database.

37. The method of claim 18 wherein processing the gathered DNS data to generate a processed data set comprises processing the DNS data to generate a summary client database.

38. The method of claim 18 wherein providing the processed data set to a second apparatus is performed using a distribution and update server.

39. The method of claim 18 further comprising storing the provided processed data set.

40. The method of claim 18 wherein gathering DNS data from a network comprises:
a) obtaining a Start of Authority (SOA) record from a database;
b) fetching a current SOA record from a remote nameserver;
c) checking for a change in the SOA record serial number,
if the serial number is unchanged then repeating step a), otherwise;
d) checking if zone transfer is allowed;
e) if zone transfer is not allowed, scanning domain;
f) if zone transfer is allowed, transferring zone;
g) entering new data into the database;
h) obtaining additional data; and
i) entering additional data into the database.

41. The method of claim 18 wherein providing processed data to a second processing apparatus comprises:
determining an update schedule at the second processing apparatus;
connecting to a distribution update server at the first processing apparatus;
requesting any changes to processed data set since previous request;
querying the distribution update server for available updates to processed data set;
if no updates are available, then downloading entire processed data set; and
if an update is available, then downloading the update to processed data set.

42. The method of claim 41 further comprising sending from the second processing apparatus to the first processing apparatus, data regarding requests made but not found in the distribution update server

43. The method of claim 18 wherein the processed data set comprises at least part of the gathered DNS data grouped and categorized.

44. The method of claim 18 wherein the processed data set comprises a summary of the gathered DNS data.

45. A system for increasing the speed of reverse DNS resolution comprising:
a first processing apparatus connected to a network for collecting DNS data and additional data on the network, comprising:
a harvesting computer adapted to collect and process DNS data and additional data,
a detailed central database adapted to store the DNS data and additional data collected by the harvesting computer,
a database of updates adapted to store the DNS data and additional data processed by the harvesting computer, and
a distribution and update server adapted to distribute the DNS data and additional data stored in the database of updates; and
a second processing apparatus, in communication with the first apparatus, adapted to perform reverse DNS resolution using processed data distributed from the first processing apparatus comprising:
a computer with RAM adapted to perform the reverse DNS resolution, and
a client web server in connection with the network which receives IP addresses for which DNS data and additional data is required.

46. In a system comprising:
a first processing apparatus connected to a network for collecting DNS data and additional data on the network, comprising:
a harvesting computer for collecting and processing the DNS and additional data,
a detailed central database for storing the DNS and additional data collected by the harvesting computer,
a database of updates for storing the DNS data and additional data processed by the harvesting computer, and
a distribution and update server for distributing the processed DNS data and additional data stored in the database of updates; and
a second processing apparatus, in communication with the first processing apparatus, for performing reverse DNS resolution using processed data distributed from the first processing apparatus comprising:
a computer with RAM for performing the reverse DNS resolution, and
a client web server in connection with the network which receives IP addresses for which DNS data is required;
a method of reverse resolution comprising:
collecting DNS data from the network using the harvesting computer;
storing the collected DNS data in the detailed central database;
collecting additional data from the network using the harvesting computer;
storing the collected additional data in the detailed database;
processing the DNS and additional data using the harvesting computer to produce a processed data set;
storing the processed data set in the database of updates;
providing the processed data to the second processing apparatus using the distribution and update server;
storing the provided processed data set in the RAM of the computer of the second processing apparatus; and
performing reverse DNS resolution on an IP address received from the client web server using the computer with the processed data set stored in RAM.
